(19) United States
(12) Patent Application Publication
(10) Pub. No.: US 2023/0093061 A1
(43) Pub. Date: Mar. 23, 2023

(54) ALLOY AND MOLDED BODY

(71) Applicants: Murata Manufacturing Co., Ltd., Kyoto-fu (JP); ALPS ALPINE CO., LTD., Tokyo (JP)

(72) Inventors: Katsutoshi UJI, Yasu-shi, Shiga (JP); Tatsuya TOMITA, Sendai-shi, Miyagi (JP); Kenji YOSHIDA, Yasu-shi, Shiga (JP)

(73) Assignees: Murata Manufacturing Co., Ltd., Kyoto-fu (JP); ALPS ALPINE CO., LTD., Tokyo (JP)

(21) Appl. No.: 17/759,245

(22) PCT Filed: Jan. 14, 2021
(86) PCT No.: PCT/JP2021/001094

§ 371 Date: Jul. 21, 2022

(30) Foreign Application Priority Data
Jan. 23, 2020 (JP) 2020-008844

(51) Int. Cl. C22C 45/02; C22C 38/54; C22C 33/00; C22C 38/42; C22C 38/52; C22C 38/02

(52) U.S. Cl. CPC C22C 45/02; C22C 33/003; C22C 38/02; C22C 38/42; C22C 38/52; C22C 38/54; C22C 2200/02; C22C 2200/04

(57) ABSTRACT

An alloy includes: an average Ni concentration of 1.5 at.% or more and 15.5 at.% or less; an average Co concentration of 0 at.% or more and 10.0 at.% or less; an average B concentration of 3.0 at.% or more and 16.0 at.% or less; an average P concentration of 0.5 at.% or more and 10.0 at.% or less; an average Cu concentration of 0 at.% or more and 2.0 at.% or less; an average Si concentration of 0 at.% or more and 6.0 at.% or less; an average C concentration of 0 at.% or more and 6.0 at.% or less; a total of average concentrations of Nb, Mo, Zr, W, V, Hf, Ta, Al, Ti, and Cr of 0 at.% or more and 6.0 at.% or less; and a total of an average Fe concentration, the average Ni concentration, and the average Co concentration of 78.0 at.% or more and 88.0 at.% or less.

### BACKGROUND

### 1. Technical Field

The present invention relates to an alloy and a molded body, for example, an alloy and a molded body containing Fe.

### 2. Description of the Related Art

An alloy containing Fe, B, and P is used as a soft magnetic material having a high saturation magnetic flux density and a low coercive force. It is known that corrosion resistance is improved by adding Cr to the alloy containing Fe, B, and P, for example, as shown in JP 2018-131683 A.

### SUMMARY

However, even when Cr is added, corrosion resistance may not be sufficient.

The present invention has been made in view of the above problems, and an object thereof is to improve corrosion resistance.

An alloy according to the present invention, the alloy includes:
an average Ni concentration of 1.5 at.% or more and 15.5 at.% or less;
an average Co concentration of 0 at.% or more and 10.0 at.% or less;
an average B concentration of 3.0 at.% or more and 16.0 at.% or less;
an average P concentration of 0.5 at.% or more and 10.0 at.% or less;
an average Cu concentration of 0 at.% or more and 2.0 at.% or less;
an average Si concentration of 0 at.% or more and 6.0 at.% or less;
an average C concentration of 0 at.% or more and 6.0 at.% or less;
a total of average concentrations of Nb, Mo, Zr, W, V, Hf, Ta, Al, Ti, and Cr of 0 at.% or more and 6.0 at.% or less; and
a total of an average Fe concentration, the average Ni concentration, and the average Co concentration of 78.0 at.% or more and 88.0 at.% or less.

An alloy according to the present invention, the alloy includes:
an average Ni concentration of more than 2.0 at.% and 9.5 at.% or less;
an average Co concentration of 0 at.% or more and 3.0 at.% or less;
an average B concentration of 8.0 at.% or more and 16.0 at.% or less;
an average P concentration of 0.5 at.% or more and 6.0 at.% or less;
an average Cu concentration of 0.1 at.% or more and 2.0 at.% or less;
an average Si concentration of 0.1 at.% or more and 6.0 at.% or less;
an average C concentration of 0 at.% or more and 6.0 at.% or less;
a total of average concentrations of Nb, Mo, Zr, W, V, Hf, Ta, Al, Ti, and Cr of 0 at.% or more and 3.0 at.% or less; and
a total of an average Fe concentration, the average Ni concentration, and the average Co concentration of 79.0 at.% or more and 88.0 at.% or less.

An alloy according to the present invention, the alloy includes:
an average Ni concentration of 3.5 at.%or more and 9.5 at.% or less;
an average Co concentration of 0 at.% or more and 0.1 at.% or less;
an average B concentration of 11.5 at.% or more and 15.5 at.% or less;
an average P concentration of 0.5 at.% or more and 4.0 at.% or less;
an average Cu concentration of 0 at.% or more and 2.0 at.% or less;
an average Si concentration of 0.1 at.% or more and 4.0 at.% or less;
an average C concentration of 0.5 at.% or more and 4.0 at.% or less;
a total of average concentrations of Nb, Mo, Zr, W, V, Hf, Ta, Al, Ti, and Cr of 0 at.% or more and 0.1 at.% or less; and
a total of an average Fe concentration, the average Ni concentration, and the average Co concentration of 81.0 at.% or more and 84.0 at.% or less.

A molded body according to the present invention includes the above alloy.

With the present invention, corrosion resistance can be improved.

### BRIEF DESCRIPTION OF THE DRAWINGS

FIG. 1 is a schematic graph showing changes in temperature with respect to time in a heat treatment for forming a nanocrystalline alloy.

FIG. 2 is a schematic cross-sectional view of the nanocrystalline alloy.

FIGS. 3A to 3C show a powder, a thin strip, and a magnetic part according to a second embodiment.

FIG. 4 shows external view photographs of samples Nos. 1 to 4, 12, and 13 after a humidity cabinet test.

### DETAILED DESCRIPTION

A nanocrystalline alloy containing Fe, B, and P has a high saturation magnetic flux density and a low coercive force. The nanocrystalline alloy includes a plurality of nanosized crystal phases formed within the amorphous phase.

A method for producing an amorphous alloy and a nanocrystalline alloy will be described. First, the amorphous alloy (precursor alloy) is formed by rapidly cooling, by an atomization method or the like, a liquid metal obtained by melting a mixture of materials or a mother alloy (cast material as a raw material). The amorphous alloy is almost in an amorphous phase and contains almost no crystal phase. That is, the amorphous alloy is composed of the amorphous phase. Depending on the conditions of rapid cooling of the liquid metal, the amorphous alloy may contain a trace amount of crystal phase. Next, the amorphous alloy is heat-treated.

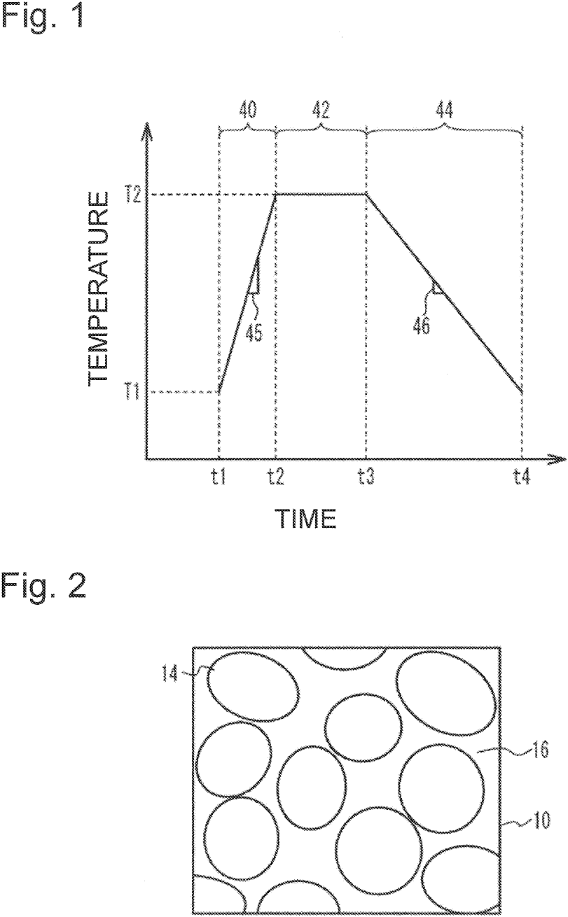

FIG. 1 is a schematic graph (schematic graph showing a temperature history of the heat treatment) showing changes in temperature with respect to time in the heat treatment for forming a nanocrystalline alloy. As shown in FIG. 1, at a time t1, the material is an amorphous alloy, and the temperature T1 is, for example, 200° C. In a heating period 40 from the time t1 to a time t2, for example, the temperature of the alloy rises from T1 to T2 at an average heating rate 45. The temperature T2 is higher than a temperature (a temperature slightly lower than a first crystallization start temperature Tx1) at which the crystal phase (metal iron crystal phase) that mainly contains iron and has the body centered cubic (BCC) structure starts to be generated and lower than a temperature (a temperature slightly lower than a second crystallization start temperature Tx2) at which the crystal phase (compound crystal phase) of a compound starts to be generated. During a retention period 42 from the time t2 to a time t3, the alloy is at a substantially constant temperature T2. In a cooling period 44 from the time t3 to a time t4, for example, the temperature of the alloy decreases from T2 to T1 at an average cooling rate 46. In FIG. 1, the heating rate 45 and the cooling rate 46 are constant, but the heating rate 45 and the cooling rate 46 may change with time.

FIG. 2 is a schematic cross-sectional view of the nanocrystalline alloy. As shown in FIG. 2, an alloy 10 includes an amorphous phase 16 and a plurality of crystal phases 14 formed in the amorphous phase 16. Each crystal phase 14 is surrounded by the amorphous phase 16. The crystal phase 14 mainly has the BCC structure, and the main element contained in this structure is Fe. The alloy 10 includes Fe (iron), Ni (nickel), B (boron), and P (phosphorus). Co (cobalt), Si (silicon), Cu (copper), and C (carbon) may be included intentionally or unintentionally. At least one element M of Nb (niobium), Mo (molybdenum), Zr (zirconium), W (tungsten), V (vanadium), Hf (hafnium), Ta (tantalum), Al (aluminum), Ti (titanium), and Cr (chromium) may be contained intentionally or unintentionally. O (oxygen) and other impurity elements may be unintentionally contained. Here, the impurity elements mean all elements other than Fe, Ni, B, P, Co, Si, Cu, C, Nb, Mo, Zr, W, V, Hf, Ta, Al, Ti, and Cr (18 elements). In addition, the other impurity elements mean all elements other than the 18 elements described above and O.

The average Fe concentration, Ni concentration, Si concentration, B concentration, P concentration, C concentration, Cu concentration, and Co concentration in the entire alloy are defined as CFe, CNi, CSi, CB, CP, CC, CCu, and CCo. The average concentration of an element group M consisting of Nb, Mo, Zr, W, V, Hf, Ta, Al, Ti, and Cr (the sum of the average concentrations of the elements in the element group M) in the entire alloy is defined as CM. The average concentration of O among the impurity elements (the remainder excluding 18 elements) in the entire alloy is defined as CO, and the average concentration of the impurity elements other than O among the impurity elements in the entire alloy is defined as Cl.

The sum of CFe, CNi, CSi, CB, CP, CC, CCu, CCo, CM, CO, and Cl is 100.0 at.%. CFe, CNi, CSi, CB, CP, CC, CCu, CCo, CM, CO, and Cl correspond to the chemical compositions of the amorphous and nanocrystalline alloys.

The size (grain size) of the crystal phase (the BCC structure mainly constituted of iron atoms) in the nanocrystalline alloy affects soft magnetic properties such as the coercive force. When the size of the crystal phase is small, the coercive force decreases, and the soft magnetic characteristics are improved. Therefore, the Scherrer diameter of the crystal phases 14 is, for example, preferably 50 nm or less, more preferably 30 nm or less, still more preferably 20 nm or less. The Scherrer diameter of the crystal phases 14 is, for example, 5 nm or more. The Scherrer diameter is determined by a general Scherrer equation. The shape factor is 0.90. The Bragg angle and the full width at half maximum of the crystal peak are determined using an X-ray diffractometer described later.

Cu serves as a nucleation site for formation of the crystal phase 14. Therefore, the nanocrystalline alloy preferably contains Cu. P contributes to reduction in size of the crystal phase 14. B and Si contribute to the formation of the amorphous phase 16. In order to reduce the size of the crystal phase 14, the content of P is preferably large, and in order to form an amorphous phase, the content of B is preferably large.

Patent Document 1 discloses that rust resistance is improved by adding Cr to an alloy containing a high concentration of P. However, it has been found that, depending on the composition of the alloy, even when Cr is added, corrosion resistance such as rust resistance is not improved in some cases. For example, in an alloy containing a high concentration of B, corrosion resistance is not improved even when Cr is added.

When the corrosion resistance of the alloy is low, the following problems may occur. When the mother alloy as a raw material of the amorphous alloy is stored for a long period of time, oxygen is easily introduced into the alloy as an impurity. When an oxide such as red rust is generated when an amorphous alloy is produced using a water atomization method, production efficiency is reduced. When the amorphous alloy is stored for a long period of time, an oxide such as red rust is easily generated. For this reason, the heat treatment for forming the nanocrystalline alloy may adversely affect the formation of nanocrystals on the surface of the alloy. As a result, deterioration of magnetic characteristics such as a decrease in saturation magnetic flux density may occur. When the amount of the oxide in the amorphous alloy increases, the chemical composition may fluctuate before and after the heat treatment for forming the nanocrystalline alloy. The oxide such as red rust promotes adhesion or aggregation of the alloy powder to a wall surface of a device such as an atomizing device. In particular, a powder having a small particle size (such as a powder having a grain size of 20 µm or less) has a large specific surface area and therefore is more likely to be adversely affected by adhesion to the wall surface of the device or oxidation of the powder.

In addition, when Cr is added to improve corrosion resistance, Cr is more likely to be distributed to the amorphous phase than the crystal phase. Therefore, the saturation magnetic flux density is likely to decrease.

### First Embodiment

In the first embodiment, the corrosion resistance of the alloy is improved by adding Ni instead of or in addition to Cr. A preferable concentration range of each element in the first embodiment is as follows. CNi is 1.5 at.% or more and 15.5 at.% or less, CCo is 0 at.% or more and 10.0 at.% or less, CB is 3.0 at.% or more and 16.0 at.% or less, CP is 0.5 at.%or more and 10.0 at.% or less, CCu is 0 at.% or more and 2.0 at.% or less, CSi is 0 at.% or more and 6.0 at.% or less, CC is 0 at.% or more and 6.0 at.% or less, CM is 0 at.% or more and 6.0 at.% or less, and the total of CFe, CNi, and CCo is 78.0 at.% or more and 88.0 at.% or less. In this way, by making CNi larger than 2.0 at.%, corrosion resistance can be improved.

### Second Embodiment

Another preferable concentration range of each element is as follows. CNi is more than 2.0 at.% and 9.5 at.% or less, CCo is 0 at.% or more and 3.0 at.% or less, CB is 8.0 at.% or more and 16.0 at.% or less, CP is 0.5 at.% or more and 6.0 at.% or less, CCu is 0.1 at.% or more and 2.0 at.% or less, CSi is 0.1 at.% or more and 6.0 at.% or less, CC is 0 at.% or more and 6.0 at.% or less, CM is 0 at.% or more and 3.0 at.% or less, and the total of CFe, CNi, and CCo is 79.0 at.% or more and 88.0 at.% or less. When CB is larger than CP, the corrosion resistance is unlikely to be improved even if Cr is added. In this case, by making CNi 3.5 at.% or more, corrosion resistance can be improved.

### Third Embodiment

Still another preferable concentration range of each element is as follows. CNi is 3.5 at.% or more and 9.5 at.% or less, CCo is 0 at.% or more and 0.1 at.% or less, CB is 11.5 at.% or more and 15.5 at.% or less, CP is 0.5 at.% or more and 4.0 at.% or less, the CCu concentration is 0 at.% or more and 2.0 at.% or less, the CSi concentration is 0.1 at.% or more and 4.0 at.% or less, CC is 0.5 at.% or more and 4.0 at.% or less, CM is 0 at.% or more and 0.1 at.% or less, and the total of CFe, CNi, and CCo is 81.0 at.% or more and 84.0 at.% or less. When CB is 11.5 at.% or more and CP is 4.0 at.% or less, the corrosion resistance is less likely to be improved even if Cr is added. In this case, by making CNi 3.5 at.% or more, corrosion resistance can be improved.

### Fourth Embodiment

Preferable concentration ranges for improving corrosion resistance and the saturation magnetic flux density are shown below. CNi is 2.5 at.% or more and 9.5 at.% or less, CB is 8.0 at.% or more and 16.0 at.% or less, CP is 0.5 at.% or more and 6.0 at.% or less, CCu is 0.1 at.% or more and 2.0 at.% or less, CSi is 0 at.% or more and 6.0 at.% or less, CC is 0 at.% or more and 6.0 at.% or less, and the total of CFe, CNi, and CCo is 79.0 at.% or more and 88.0 at.% or less.

### Fifth Embodiment

Preferable concentration ranges for improving corrosion resistance and the saturation magnetic flux density and reducing the coercive force are shown below. CNi is 2.5 at.% or more and 9.5 at.% or less, CB is 3.0 at.% or more and 16.0 at.% or less, CP is 0.5 at.% or more and 10.0 at.% or less, CCu is 0.1 at.% or more and 2.0 at.% or less, CSi is 0 at.% or more and 3.5 at.% or less, CC is 0 at.% or more and 6.0 at.% or less, and the total of CFe, CNi, and CCo is 79.0 at.% or more and 88.0 at.% or less. By increasing CP and decreasing CB, the crystal phases 14 of nanocrystals become small, and the coercive force becomes small.

### Sixth Embodiment

Preferable concentration ranges for further improving corrosion resistance are shown below. CNi is 3.0 at.% or more and 10.0 at.% or less, CB is 8.0 at.% or more and 16.0 at.% or less, CP is 1.0 at.% or more and 6.0 at.% or less, CCu is 0 at.% or more and 2.0 at.% or less, CSi is 0 at.% or more and 6.0 at.% or less, CC is 0 at.% or more and 6.0 at.% or less, and the total of CFe, CNi, and CCo is 79.0 at.% or more and 88.0 at.% or less. The corrosion resistance can be further improved by increasing CNi and CB and decreasing CP.

The first to sixth embodiments may be nanocrystalline alloys or amorphous alloys. In the case of a nanocrystalline alloy, the Scherrer diameter of the crystal phase 14 having the BCC structure containing Fe is preferably 25 nm or less, more preferably 20 nm or less. With such a diameter, the coercive force can be reduced. The amount of crystal phases 14 having a structure (such as the face centered cubic (FCC) structure) other than the BCC structure among the crystal phase 14 is preferably as small as possible because soft magnetic characteristics are easily deteriorated.

By setting CFe + CNi + CCo to 78.0 at.% or more, the saturation magnetic flux density can be increased. CFe + CNi + CCo is preferably 79.0 at.% or more, more preferably 81.0 at.% or more. By increasing the concentrations of the metalloids (B, P, C, and Si), the amorphous phase 16 can be more stably provided between the crystal phases 14. Therefore, CFe + CNi + CCo is preferably 88.0 at.% or less, more preferably 85.0 at.% or less, still more preferably 84.0 at.% or less.

By increasing CNi, corrosion resistance can be improved. CNi is 1.5 at.% or more, preferably more than 2.0 at.%, more preferably 2.5 at.% or more, still more preferably 3.0 at.% or more. When CNi is too high, CFe decreases, and the saturation magnetic flux density decreases. CNi is therefore preferably 15.5 at.% or less, more preferably 9.5 at.% or less.

The alloy may not contain Co, but the alloy may unintentionally or intentionally contain Co. That is, CCo is 0 at.% or more and may be 0.1 at.% or more. Co greatly improves the saturation magnetic flux density but may increase the magnetostriction. Therefore, even when the alloy contains Co, CCo is 10.0 at.% or less. The content of Co is preferably 3.0 at.% or less, more preferably 1.0 at.% or less, still more preferably 0.1 at.% or less, because Co significantly increases the raw material cost of the alloy.

When CB is high, the amorphous phase 16 can be stably formed. Therefore, CB is preferably 3.0 at.% or more, more preferably 8.0 at.% or more, still more preferably 11.5 at.% or more. In order to increase CB and to set CFe + CNi + CCo to 78.0 at.% or more, CP is lowered. If CP is too low, the coercive force will be high. CB is therefore preferably 16.0 at.% or less, more preferably 15.5 at.% or less.

When CP is high, the crystal phases 14 become small, and the coercive force decreases. CP is therefore preferably 0.5 at.% or more, more preferably 1.0 at.% or more. In order to increase CP and to set CFe + CNi + CCo to 78.0 at.% or more, CB and CSi are lowered. If CB and CSi are too low, it becomes difficult to stably form the amorphous phase 16. Therefore, CP is preferably 10.0 at.% or less, more preferably 6.0 at.% or less, still more preferably 4.0 at.% or less.

The alloy may not contain Si, but the alloy may unintentionally or intentionally contain Si. That is, CSi is 0 at.% or more and may be 0.1 at.% or more. For stable production, Tx2 is preferably high. Higher CSi results in higher Tx2. CSi is therefore preferably 0.1 at.% or more, more preferably 0.5 at.% or more. In order to increase CSi and to set CFe + CNi + CCo to 78.0 at.% or more, CP and CB are lowered. If CP is too low, the coercive force becomes high, and if CB is too low, the amorphous phase cannot be stably produced. Therefore, CSi is preferably 6.0 at.% or less, more preferably 4.0 at.% or less, still more preferably 3.5 at.% or less.

The alloy may not contain Cu, but the alloy may unintentionally or intentionally contain Cu. That is, CCu is 0 at.% or more and may be 0.1 at.% or more. If there is a Cu cluster in the initial stage of formation of the crystal phase 14, the Cu cluster becomes a nucleation site, and the crystal phase 14 is stably formed. CCu is therefore preferably 0.1 at.% or more, more preferably 0.5 at.% or more. If the amount of Cu is large, the saturation magnetic flux density decreases. From these viewpoints, CCu is preferably 2.0 at.% or less, more preferably 1.5 at.% or less.

The alloy may not contain each element (Nb, Mo, Zr, W, V, Hf, Ta, Al, Ti, and Cr) constituting the element group M, but the alloy may unintentionally or intentionally contain the elements M. That is, CM is 0 at.% or more and may be 0.1 at.% or more. CM is preferably 3.0 at.% or less, more preferably 2.0 at.% or less, still more preferably 1.0 at.% or less.

When the average concentration of an element group M1 consisting of Nb, Mo, Zr, W, V, Hf, and Ta (the sum of the average concentrations of the respective elements of the element group M1) in the entire alloy is defined as CM1, and the average concentration of an element group M2 consisting of Al, Ti, and Cr (the sum of the average concentrations of the respective elements of the element group M2) in the entire alloy is defined as CM2, CM1 is preferably 3.0 at.% or less, more preferably 2.0 at.% or less, still more preferably 1.0 at.% or less. CM2 is preferably 3.0 at.% or less, more preferably 2.0 at.% or less, still more preferably 1.0 at.% or less.

The alloy preferably does not intentionally contain O or other elements. That is, Cl and CO are 0 at.% or more. CO is preferably 5.0 at.% or less, more preferably 3.0 at.% or less, still more preferably 1.0 at.% or less. Cl is preferably 1.0 at.% or less, more preferably 0.5 at.% or less, still more preferably 0.1 at.% or less. In addition, the average concentration of each unintended element other than O in the entire alloy is preferably 0.5 at.% or less, more preferably 0.1 at.% or less.

From the above, essential elements are Fe, Ni, B, and P, and optional elements are Co, Cu, Si, C, Nb, Mo, Zr, W, V, Hf, Ta, Al, Ti, and Cr. When the alloy does not contain the optional elements, the alloy is composed of Ni, B, P, and the remainder consisting of Fe and the impurity elements. When the alloy contains the optional elements, the alloy is composed of Ni, B, P, the optional elements, and the remainder consisting of Fe and the impurity elements. CFe is 52.5 at.% or more and 86.5 at.% or less. Fe is inexpensive and improves the saturation magnetic flux density. Therefore, CFe is preferably 62.5 at.% or more, more preferably 68.0 at.% or more, still more preferably 72.0 at.% or more.

### Manufacturing Method of First Embodiment

A method for producing an amorphous alloy and a nanocrystalline alloy will be described below. The method for producing the alloy according to the first embodiment is not limited to the following method.

### Method for Producing Amorphous Alloy

A single roll method is used for producing the amorphous alloy. The conditions of the roll diameter and the rotation speed in the single roll method are arbitrary. The single roll method is suitable for producing an amorphous alloy because it is easy to rapidly cool. The cooling rate of the alloy molten for the production of the amorphous alloy is, for example, preferably 10⁴ °C/sec or more, preferably 10⁶ °C/sec or more. A method other than the single roll method including a period in which the cooling rate is 10⁴ °C/sec may be used. For the production of the amorphous alloy, for example, a water atomization method or the atomization method described in Japanese Patent No. 6533352 may be used.

### Method for Producing Nanocrystalline Alloy

The nanocrystalline alloy is obtained by heat treatment of the amorphous alloy. In the production of the nanocrystalline alloy, the temperature history in the heat treatment affects the nanostructure of the nanocrystalline alloy. For example, in the heat treatment as shown in FIG. 1, the heating rate 45, the retention temperature T2, the length of the retention period 42, and the cooling rate 46 mainly affect the nanostructure of the nanocrystalline alloy.

### Heating Rate

When the heating rate 45 is high, the size of each crystal phase 14 decreases, and the coercive force of the alloy decreases. In addition, the saturation magnetic flux density may increase. For example, in the temperature range from 200° C. to the retention temperature T2, an average heating rate ΔT is preferably 360° C./min or more, more preferably 400° C./min or more. It is more preferable that the average heating rate calculated in increments of 10° C. in this temperature range satisfies the same condition. However, when it is necessary to release heat associated with crystallization as in the heat treatment after lamination, it is preferable to reduce the average heating rate. For example, such an average heating rate may be 5° C./min or less.

### Length of Retention Period

The length of the retention period 42 is preferably a time in which it can be determined that crystallization has sufficiently progressed. In order to determine that the crystallization has sufficiently progressed, it is confirmed that a first peak corresponding to the first crystallization start temperature Tx1 cannot be observed or has become very small (for example, the calorific value was ⅟100 or less of the total calorific value of the first peak in the DSC curve of the amorphous alloys having the same chemical composition) in a curve (DSC curve) obtained by heating the nanocrystalline alloy to about 650° C. at a constant heating rate of 40 °C/min by differential scanning calorimetry (DSC).

When crystallization (crystallization at the first peak) approaches 100%, the rate of crystallization is very slow, and it may be impossible to determine by DSC whether crystallization has sufficiently progressed. Therefore, the length of the retention period is preferably longer than expected from the DSC result. For example, the length of the retention period is preferably 0.5 minutes or more, more preferably 5 minutes or more. The saturation magnetic flux density can be increased by sufficiently performing crystallization. If the retention period is too long, the producibility of the nanocrystalline alloy decreases. Therefore, the length of the retention period is preferably 60 minutes or less, more preferably 30 minutes or less.

### Retention Temperature

The maximum temperature Tmax of the retention temperature T2 is preferably the first crystallization start temperature Tx1 - 20° C. or more and the second crystallization start temperature Tx2 - 20° C. or less. When Tmax is less than Tx1 - 20° C., crystallization does not sufficiently proceed. When Tmax exceeds Tx2 - 20° C., a compound crystal phase is formed, and the coercive force greatly increases. In addition, Tmax is preferably the Curie temperature of the amorphous phase 16 or more.

### Cooling Rate

If the cooling rate 46 is high, strain tends to be left in the nanocrystalline alloy. On the other hand, if the cooling rate 46 is low, it takes time to produce the nanocrystalline alloy. The cooling rate 46 is defined as the average cooling rate from when the temperature of the alloy reaches Tmax to 200° C. The cooling rate 46 is preferably, for example, 0.1 °C/sec or more and 1.0 °C/sec or less. From the viewpoint of enhancing the production efficiency, the average cooling rate may be, for example, 100 °C/min or more.

### Amorphous Alloy

The amorphous alloy as the precursor alloy of the nanocrystalline alloy in the first to sixth embodiments is composed of the amorphous phase. Here, the phrase “composed of the amorphous phase” means that a trace amount of a crystal phase may be contained as long as the effects of the first to sixth embodiments can be obtained.

An example of a method for determining whether the alloy is composed of the amorphous phase will be described. Determination is performed using a diffraction pattern (for example, X-ray source: Cu-Ka ray; 1 step 0.02°; measurement time per step: 10 seconds) obtained with an X-ray diffractometer (such as 45 kV and 200 mA in Smartlab (registered trademark)-9 kW manufactured by Rigaku Corporation equipped with a counter monochromator).

Even when a peak of iron having the BCC structure is not observed in the diffraction pattern, a trace amount of a crystal phase may be observed with a transmission electron microscope. However, it is difficult to quantify such a trace amount of crystal phases, and the influence on magnetic properties is also slight. Therefore, even when a trace amount of crystal phases is observed with a transmission electron microscope, it is considered that the amorphous alloy is composed of the amorphous phase.

### Nanocrystalline Alloy

The nanocrystalline alloy 10 in the first to sixth embodiments includes, the amorphous phase 16, and the crystal phases 14 formed in the amorphous phase 16. The proportion of the crystal phases 14 in the alloy 10 may be any proportion as long as the effects of the first to sixth embodiments can be obtained. For example, the alloy 10 includes crystal phases 14 to such an extent that a peak of iron having the BCC structure is observed in the diffraction pattern obtained with the X-ray diffractometer described above. When the amount of the crystal phases 14 is large, the alloy tends to be brittle, so that the alloy tends to break during winding. Therefore, the amount of the crystal phases 14 can be appropriately adjusted according to the usage.

### Seventh Embodiment

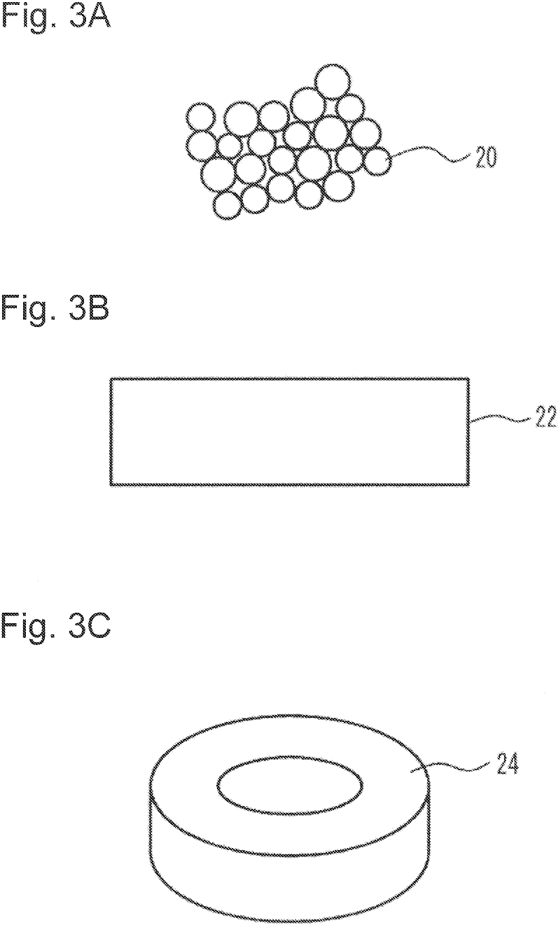

FIGS. 3Ato 3C show a powder, a thin strip, and a magnetic part according to a seventh embodiment. As shown in FIG. 3A, a powder 20 may include any of the alloys according to the first to sixth embodiments. The grain size of the powder 20 is evaluated by a median diameter from a particle size distribution obtained by a laser diffraction/scattering method. D90 of the powder 20 is, for example, 3 µm to 100 µm, D50 of the powder 20 is, for example, 2 to 50 µm, and D10 of the powder 20 is, for example, 0.5 to 20 µm . As shown in FIG. 3B, a thin strip 22 may include the alloy according to the embodiment. The width of the thin strip 22 is, for example, 1 to 500 mm, and the thickness is, for example, 8 to 60 µm. As shown in FIG. 3C, a soft magnetic core 24 may include the alloy according to the first embodiment. The soft magnetic core 24 is, for example, a molded body obtained by molding a mixture containing the powder of FIG. 3A and a binding material. The binding material is preferably composed of a resin. The molded body may be a magnetic part other than the soft magnetic core 24.

### Example 1

A sample ribbon was prepared as follows.

### Production of Amorphous Alloy

As starting materials of the alloy, reagents such as iron (impurities of 0.01 wt% or less), boron (impurities of less than 0.5 wt%), triiron phosphide (impurities of less than 1 wt%), copper (impurities of less than 0.01 wt%), silicon (impurities of 0.001 wt% or less), carbon (impurities of 0.05 wt% or less), nickel (impurities of 0.1 wt% or less), chromium (impurities of 0.01 wt% or less), and molybdenum (impurities of 0.1 wt% or less) were prepared. In the process of producing a nanocrystalline alloy from a mixture of these reagents, it was confirmed in advance that loss or mixing of elements did not occur. In this confirmation, among the chemical elements in the amorphous alloy and the nanocrystalline alloy, the B concentration CB was determined by absorptiometry, the C concentration CC was determined by infrared spectroscopy, and the Ni concentration CNi, the Cu concentration CCu, the Cr concentration CCr, the Mo concentration CMo, the P concentration CP, and the Si concentration CSi were determined by high-frequency inductively coupled plasma optical emission spectrometry. The Fe concentration CFe was determined as the remainder by subtracting the total concentration of chemical elements other than Fe from 100%.

Prepared was 200 g of the mixture having a desired chemical composition. The mixture was heated in a crucible in an argon atmosphere to form a uniform molten metal. The molten metal was solidified in a copper mold to produce an ingot.

An amorphous alloy was produced from the ingot by a single roll method. In a quartz crucible, 30 grams of the ingot was molten and ejected from a nozzle having an opening of 10 mm * 0.3 mm into a rotating roll made of pure copper. An amorphous ribbon having a width of 10 mm and a thickness of 20 µm was formed as an amorphous alloy on the rotating roll. The amorphous ribbon was stripped from the rotating roll by an argon gas jet. Using an X-ray diffractometer, it was confirmed by the above-described method that the amorphous ribbon was an amorphous alloy composed of an amorphous phase.

Heat treatment was performed in an argon stream using an infrared gold image furnace to produce a nanocrystalline alloy ribbon from the amorphous alloy. As heat treatment conditions, the heating rate is 400 °C/min, the length of the retention period is 1 minute, and the average cooling rate from 425° C. to 225° C. is 16 °C/min. A retention temperature Th (heat treatment temperature) was varied, and a sample treated at a retention temperature at which the coercive force was the smallest was used.

### Determination of Crystallization Temperature

For the amorphous alloy of each sample, the crystallization temperatures (Tx1 and Tx2) were determined by DSC. The amount of the sample was set to 20 mg, and the heating rate of DSC was set to a constant rate of 40 °C/min.

Table 1 shows the chemical composition (concentrations), Tx1, Tx2, ΔTx = Tx1 - Tx2, and the retention temperature Th of each sample. The sum of CFe, CNi, CSi, CB, CP, CC, CCu, CCr, and CMo is 100 at.%.

Table 1

| Sample No. | Chemical composition [at.%] | | | | | | | | | | Tx1 | Tx2 | ΔTx | Th |
|---|---|---|---|---|---|---|---|---|---|---|---|---|---|---|
| | CFe | CNi | CSi | CB | CP | CC | CCu | CCr | CMo | CFe + CNi | [°C] | [°C] | [°C] | [°C] |
| 1 | 82.3 | 0.0 | 0.5 | 13.5 | 1.0 | 2.0 | 0.7 | 0.0 | 0.0 | 82.3 | 438 | 532 | 95 | 450 |
| 2 | 80.3 | 2.0 | 0.5 | 13.5 | 1.0 | 2.0 | 0.7 | 0.0 | 0.0 | 82.3 | 437 | 528 | 92 | 450 |
| 3 | 78.3 | 4.0 | 0.5 | 13.5 | 1.0 | 2.0 | 0.7 | 0.0 | 0.0 | 82.3 | 434 | 522 | 89 | 460 |
| 4 | 76.3 | 6.0 | 0.5 | 13.5 | 1.0 | 2.0 | 0.7 | 0.0 | 0.0 | 82.3 | 433 | 517 | 84 | 460 |
| 12 | 72.3 | 10.0 | 0.5 | 13.5 | 1.0 | 2.0 | 0.7 | 0.0 | 0.0 | 82.3 | 431 | 507 | 76 | 460 |
| 13 | 67.3 | 15.0 | 0.5 | 13.5 | 1.0 | 2.0 | 0.7 | 0.0 | 0.0 | 82.3 | 428 | 496 | 67 | 440 |
| 5 | 80.7 | 0.0 | 0.5 | 13.5 | 1.0 | 2.0 | 0.7 | 1.6 | 0.0 | 80.7 | 443 | 538 | 94 | 470 |
| 11 | 80.8 | 0.0 | 0.5 | 14.0 | 0.5 | 2.0 | 0.7 | 1.0 | 0.5 | 80.8 | 427 | 539 | 112 | 460 |

Samples Nos. 1, 5, and 11 are Comparative Example 1 and have a CNi of 0 at.%. Samples Nos. 2 to 4, 12, and 13 have a CNi of 2.0 at.% to 15.0 at.% and are Example 1.

### Measurement of Saturation Magnetic Flux Density and Coercive Force

For the nanocrystalline alloy of each sample, a saturation magnetic flux density Bs was measured with a vibrating sample magnetometer VSM-P7, and a coercive force Hc was measured with a BH tracer model BHS-40. As the density used for calculating the saturation magnetic flux density Bs, an actual measurement value determined using the Archimedes' method was used.

### Measurement of Weight Increase

For the amorphous alloy (precursor alloy) of each sample, rust resistance was measured by the following humidity cabinet test. A ribbon piece of 10 mm * 70 mm was suspended in the air atmosphere such that the long side direction coincided with the vertical direction. With an adhesive tape, 5 mm of an end surface in the longitudinal direction of the ribbon piece was protected, and the protected portion was sandwiched between two plates to fix the ribbon piece in the vertical direction. In the humid atmosphere after the start of the humidity cabinet test, the temperature is 60° C., and the relative humidity is 90%. A weight change ΔW500 after exposure to a humid atmosphere for 500 hours from the weight of each sample before the test was measured. In addition, a weight change ΔW1000 after exposure to a humid atmosphere for 1,000 hours from the weight of each sample before the test was measured. ΔW500 and ΔW1000 are expressed in weight per square centimeter. The case where ΔW500 and ΔW1000 are 0 corresponds to the case where almost no rust has been generated in the sample, and the case where ΔW500 and ΔW1000 increase corresponds to the case where much rust has been generated.

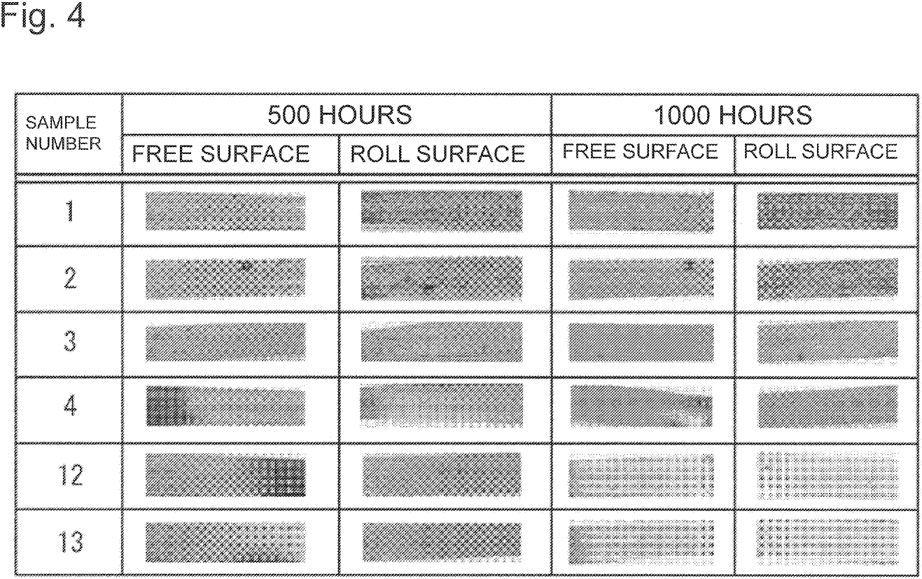

FIG. 4 shows external view photographs of the samples Nos. 1 to 4, 12, and 13 after a humidity cabinet test. The photographs labeled as 500 hours are photographs of the amorphous alloys of the respective samples that have been exposed to a humid atmosphere for 500 hours, and the photographs labeled as 1,000 hours are photographs of the amorphous alloys that have been exposed to a humid atmosphere for 1,000 hours. A free surface is a surface to be an outer side (surface not in contact with a roll) when a thin strip is formed on the roll by the single roll method, and a roll surface is a surface to be an inner side (surface in contact with the roll).

### Measurement of Iron Loss

For the nanocrystalline alloy of each sample, the iron loss was measured as follows. For the measurement of the iron loss, a B-H analyzer SY-8219 and a small single-sheet magnetometer SY-956 were used. The measurement sample is a ribbon piece of 10 mm * 70 mm. An iron loss W10/50 at an amplitude of the magnetic flux density of 1.0 T and a frequency of 50 Hz, an iron loss W15/50 at an amplitude of the magnetic flux density of 1.5 T and a frequency of 50 Hz, and an iron loss W10/1000 at an amplitude of the magnetic flux density of 1.0 T and a frequency of 1 kHz were measured.

### Measurement of Magnetic Permeability

For the nanocrystalline alloy of each sample, a magnetic permeability µa was measured as follows. For the measurement of the magnetic permeability, a B-H analyzer SY-8219 and a small single-sheet magnetometer SY-956 were used. The measurement sample is a ribbon piece of 10 mm * 70 mm. The frequency was 50 Hz, and the magnetic field was 30 A/m.

Table 2 shows the saturation magnetic flux density Bs, the coercive force Hc, the weight changes ΔW500 and ΔW1000, the iron losses W10/50, W15/50, and W10/1000, and the magnetic permeability µa of each sample. The symbol “-” in W15/50 means unmeasurable.

Table 2

| Sample No. | Bs | Hc | ΔW500 | ΔW1000 | W10/50 | W15/50 | W10/1000 | µa |
|---|---|---|---|---|---|---|---|---|
| | [T] | [A/m] | [µg/cm²] | [µg/cm²] | [W/kg] | [W/kg] | [W/kg] | [-] |
| 1 | 1.75 | 5.8 | 43 | 73 | 0.31 | 0.58 | 9.42 | 26847 |
| 2 | 1.73 | 5.1 | 33 | 65 | 0.27 | 0.51 | 8.61 | 30542 |
| 3 | 1.73 | 7.3 | 18 | 28 | 0.22 | 0.48 | 6.43 | 35165 |
| 4 | 1.71 | 6.4 | 5 | 10 | 0.24 | 0.48 | 7.91 | 29131 |
| 12 | 1.65 | 6.9 | 0 | 4 | 0.29 | 0.61 | 9.14 | 23696 |
| 13 | 1.55 | 14.5 | 0 | 0 | 0.40 | | 11.28 | 16488 |
| 5 | 1.66 | 6.3 | 55 | 96 | 0.29 | 0.55 | 8.72 | 26934 |
| 11 | 1.70 | 9.4 | 69 | 94 | 0.39 | 0.72 | 11.64 | 20985 |

As shown in Table 1, Table 2, and FIG. 4, in the sample No. 1 not containing Cr or Ni, ΔW500 and ΔW1000 are large, and red rust is generated on the surface. As shown in Table 2, in the samples No. 5 and No. 11 to which Cr was added, ΔW500 and ΔW1000 become large. Thus, the addition of Cr may deteriorate rust resistance. In Patent Document 1, CP is larger than CB, whereas in the samples No. 1, No. 5, and No. 11, CB is larger than CP, which may be a factor in lowering the rust resistance due to the addition of Cr.

As shown in Table 1, in the samples Nos. 2 to 4,12, and 13, Ni was added instead of Cr. CFe + CNi was constant at 82.3 at.%. As shown in FIG. 4, red rust is generated in the sample No. 1 in 500 hours. Red rust is generated in the sample No. 2 in 500 hours as in the sample No. 1. In the sample No. 3, the generation of red rust is small even after 1,000 hours. In the samples Nos. 4, 12, and 13, red rust is hardly generated even after 1,000 hours.

As shown in Table 2, in the sample No. 2, ΔW500 and ΔW1000 are slightly lower than those in the sample No. 1. In the sample No. 3, ΔW500 and ΔW1000 are smaller than those in the sample No. 1. In the samples No. 4, No. 12, and No. 13, ΔW500 and ΔW1000 are substantially zero.

The saturation magnetic flux densities Bs, the coercive forces Hc, the iron losses W10/50, W15/50, and W10/1000 of the samples Nos. 2 to 4, 12, and 13 are almost the same as those of the sample No. 1. The saturation magnetic flux density Bs of the sample No. 13 is smaller than Bs of the sample No. 1, and the coercive force Hc and the iron losses W10/50, W15/50, and W10/1000 of the sample No. 13 are larger than those of the sample No. 1. The magnetic permeability µa is high in the samples Nos. 2 to 4, slightly low in the sample No. 12, and low in the sample No. 13.

As described above, when CNi is increased, rust resistance is improved. In particular, when CNi is more than 2 at.%, rust resistance is improved, when CNi is 4 at.% or more, rust resistance is further improved, and when CNi is 6 at.% or more, rust resistance is further improved. On the other hand, magnetic characteristics are slightly deteriorated when CNi is 10 at.% or more and further deteriorated when CNi is 13 at.% or more. As described above, from the viewpoint of corrosion resistance, CNi is preferably more than 2 at.%, more preferably 4 at.% or more. From the viewpoint of magnetic characteristics, CNi is preferably less than 13 at.%, more preferably 10 at.% or less.

### Example 2

A sample powder was prepared as follows.

### Production of Amorphous Alloy and Nanocrystalline Alloy

Industrial raw materials such as pure iron, ferroboron, ferrophosphorus, pure copper, pure silicon, pure nickel, and graphite were prepared so as to constitute a desired chemical composition, and these were heated in a crucible to form a uniform molten metal. The molten metal was pulverized and quenched by a water atomization method to provide a slurry. From the powder obtained by drying the slurry, powder of 20 µm or more was removed through a sieve. MiniFlex 600 M (tube voltage: 40 kV, tube current: 15 mA, X-ray source: Cu-Ka ray; 1 step 0.01°; measurement time per step: 10 seconds) manufactured by Rigaku Corporation was used as an X-ray diffractometer to confirm whether the powder was an amorphous alloy composed of the amorphous phase (amorphous powder).

Heat treatment was performed in an argon stream using an infrared gold image furnace to produce a nanocrystalline alloy powder from the amorphous alloy. As heat treatment conditions, the heating rate is 400 °C/min, the length of the retention period is 1 minute, and the average cooling rate from 425° C. to 225° C. is 16 °C/min. A retention temperature Th (heat treatment temperature) was varied, and a sample treated at a retention temperature at which the coercive force was the smallest was used.

For a sample No. 14, since the powder before the heat treatment contained a sufficient amount of the crystal phase and was determined not to be an amorphous powder, heat treatment for forming a nanocrystalline alloy was not performed. For samples Nos. 15 to 22, since the powders were amorphous powders, heat treatment for forming a nanocrystalline alloy was performed.

### Determination of Crystallization Temperature

For the amorphous alloy of each sample, the crystallization temperatures (Tx1 and Tx2) were determined by DSC. The amount of the sample was set to 20 mg, and the heating rate of DSC was set to a constant rate of 40 °C/min. For the sample No. 22, Tx2 could not be determined due to the problem of the maximum temperature reached using the DSC.

Table 3 shows the chemical composition (concentrations), Tx1, Tx2, ΔTx = Tx1 - Tx2, and the retention temperature Th of each sample. CNb is the average Nb concentration in the entire alloy. The sum of CFe, CNi, CSi, CB, CP, CC, CCu, and CNb is 100 at.%.

Table 3

| Sample No. | Chemical composition [at.%] | | | | | | | | | Tx1 | Tx2 | ΔTx | Th |
|---|---|---|---|---|---|---|---|---|---|---|---|---|---|
| | CFe | CNi | CSi | CB | CP | CC | CCu | CNb | CFe + CNi | [°C] | [°C] | [°C] | [°C] |
| 14 | 85.0 | 0.0 | 0.5 | 9.0 | 3.6 | 1.0 | 0.8 | 0.0 | 85.0 | 393 | 512 | 119 | |
| 15 | 75.3 | 6.0 | 2.0 | 14.0 | 1.0 | 1.0 | 0.7 | 0.0 | 81.3 | 450 | 519 | 69 | 440 |
| 16 | 75.3 | 6.0 | 3.0 | 14.0 | 1.0 | 0.0 | 0.7 | 0.0 | 81.3 | 464 | 526 | 61 | 460 |
| 17 | 76.3 | 6.0 | 3.0 | 13.0 | 1.0 | 0.0 | 0.7 | 0.0 | 82.3 | 445 | 519 | 74 | 460 |
| 18 | 77.3 | 6.0 | 3.0 | 12.0 | 1.0 | 0.0 | 0.7 | 0.0 | 83.3 | 419 | 518 | 100 | 460 |
| 19 | 78.3 | 6.0 | 3.0 | 11.0 | 1.0 | 0.0 | 0.7 | 0.0 | 84.3 | 426 | 519 | 93 | 460 |
| 20 | 76.3 | 6.0 | 2.0 | 13.0 | 1.0 | 0.0 | 0.7 | 1.0 | 82.3 | 432 | 545 | 113 | 470 |
| 21 | 75.3 | 6.0 | 2.0 | 14.0 | 1.0 | 0.0 | 0.7 | 1.0 | 81.3 | 435 | 548 | 113 | 490 |
| 22 | 73.5 | 0.0 | 13.5 | 9.0 | 0.0 | 0.0 | 1.0 | 3.0 | 73.5 | 544 | | | 530 |

The samples Nos. 14 and 22 are Comparative Example 2 and have a CNi of 0 at.%. The samples Nos. 15 to 21 have a CNi of 6.0 at.% and are Example 2.

### Measurement of Saturation Magnetic Flux Density and Coercive Force

For the nanocrystalline alloy of each sample, the saturation magnetic flux density Bs was measured with a vibrating sample magnetometer VSM-P7, and the coercive force Hc was measured with a coercive force meter K-HC1000. As the density used for calculating the saturation magnetic flux density Bs, 7.5 g/cm³ was employed.

### Measurement of Particle Size Distribution and Observation of Powder Color

For the amorphous alloy of each sample, the particle size distribution was measured with Microtrac MT3300EXII under sufficient dispersion conditions to determine D10, D90, and the median diameter D50. In addition, the color of the surface of the amorphous alloy of each sample was visually observed.

Table 4 shows the saturation magnetic flux density Bs, the coercive force Hc, D10, D50, D90, and the powder color of each sample.

Table 4

| Sample No. | Bs | Hc | Particle size distribution [µm] | | | Powder color |
|---|---|---|---|---|---|---|
| | [T] | [A/m] | D10 | D50 | D90 | |
| 14 | 1.67 | > 19999 | 0.2 | 6.4 | 14.3 | Reddish brown |
| 15 | 1.54 | 279 | 1.5 | 3.6 | 9.1 | Grayish brown |
| 16 | 1.52 | 187 | 1.5 | 3.6 | 9.2 | Grayish brown |
| 17 | 1.54 | 327 | 2.1 | 6.4 | 16.6 | Grayish brown |
| 18 | 1.55 | 652 | 1.3 | 3.2 | 11.1 | Grayish brown |
| 19 | 1.53 | 604 | 1.4 | 3.4 | 9.9 | Grayish brown |
| 20 | 1.59 | 462 | 4.1 | 6.3 | 11.0 | Grayish brown |
| 21 | 1.46 | 283 | 1.4 | 4.0 | 11.7 | Grayish brown |
| 22 | 1.18 | 197 | 1.5 | 3.5 | 9.1 | Grayish brown |

As shown in Table 4, in the sample No. 14, the powder turned reddish brown, and red rust was generated on the surface. On the other hand, in the samples Nos. 15 to 21, the powder turned to grayish brown, and the generation of red rust on the surface could be reduced. As described above, when CNi is increased, rust resistance is improved. As in the samples Nos. 15 to 21, CFe + CNi is 78.0 at.% to 88.0 at.%, preferably 79.0 at.% to 88.0 at.%, more preferably 81 at.% to 84 at.%. With this constitution, the saturation magnetic flux density Bs can be increased, and the coercive force Hc can be decreased. As in the samples Nos. 20 and 21, at least one element of Nb, Mo, Zr, W, V, Hf, Ta, Al, Ti, and Cr may be contained in an amount of 6.0 at.% or less, preferably 3.0 at.% or less.

Although the preferable examples of the invention have been described in detail above, the present invention is not limited to the specific examples, and various modifications and changes can be made within the scope of the gist of the present invention described in the claims.

### REFERENCE NUMERALS

10 alloy
14 crystal phase
16 amorphous phase

1. An alloy including:
an average Ni concentration of 1.5 at.% or more and 15.5 at.% or less;
an average Co concentration of 0 at.% or more and 10.0 at.% or less;
an average B concentration of 3.0 at.% or more and 16.0 at.% or less;
an average P concentration of 0.5 at.% or more and 10.0 at.% or less;
an average Cu concentration of 0 at.% or more and 2.0 at.% or less;
an average Si concentration of 0 at.% or more and 6.0 at.% or less;
an average C concentration of 0 at.% or more and 6.0 at.% or less;
a total of average concentrations of Nb, Mo, Zr, W, V, Hf, Ta, Al, Ti, and Cr of 0 at.% or more and 6.0 at.% or less; and
a total of an average Fe concentration, the average Ni concentration, and the average Co concentration of 78.0 at.% or more and 88.0 at.% or less.

2. An alloy including:
an average Ni concentration of more than 2.0 at.% and 9.5 at.% or less;
an average Co concentration of 0 at.% or more and 3.0 at.% or less;
an average B concentration of 8.0 at.%or more and 16.0 at.% or less;
an average P concentration of 0.5 at.% or more and 6.0 at.% or less;
an average Cu concentration of 0.1 at.% or more and 2.0 at.% or less;
an average Si concentration of 0.1 at.% or more and 6.0 at.% or less;
an average C concentration of 0 at.% or more and 6.0 at.% or less;
a total of average concentrations of Nb, Mo, Zr, W, V, Hf, Ta, Al, Ti, and Cr of 0 at.% or more and 3.0 at.% or less; and
a total of an average Fe concentration, the average Ni concentration, and the average Co concentration of 79.0 at.% or more and 88.0 at.% or less.

3. An alloy including:
an average Ni concentration of 3.5 at.% or more and 9.5 at.% or less;
an average Co concentration of 0 at.% or more and 0.1 at.% or less;
an average B concentration of 11.5 at.% or more and 15.5 at.% or less;
an average P concentration of 0.5 at.% or more and 4.0 at.% or less;
an average Cu concentration of 0 at.% or more and 2.0 at.% or less;
an average Si concentration of 0.1 at.% or more and 4.0 at.% or less;
an average C concentration of 0.5 at.% or more and 4.0 at.% or less;
a total of average concentrations of Nb, Mo, Zr, W, V, Hf, Ta, Al, Ti, and Cr of 0 at.% or more and 0.1 at.% or less; and
a total of an average Fe concentration, the average Ni concentration, and the average Co concentration of 81.0 at.% or more and 84.0 at.% or less.

4. A molded body comprising the alloy according to claim 1.
